(19) United States
(12) Patent Application Publication
(10) Pub. No.: US 2026/0361824 A1
(43) Pub. Date: Nov. 12, 2026

(54) IMAGE READING APPARATUS, CONTROL METHOD THEREFOR, AND NON-TRANSITORY COMPUTER-READABLE STORAGE

(71) Applicant: CANON KABUSHIKI KAISHA, Tokyo (JP)

(72) Inventors: NORIKAZU HONDA, Kanagawa (JP); YUICHI YANAGIWARA, Tokyo (JP); YUYA YASUDA, Tokyo (JP); KAZUKI MATSUO, Tokyo (JP)

(21) Appl. No.: 19/667,758

(22) Filed: May 5, 2026

(30) Foreign Application Priority Data
May 8, 2025 (JP) 2025-078180

(51) Int. Cl. H04N 1/00

(52) U.S. Cl. CPC H04N 1/00745; H04N 1/00018; H04N 1/00037; H04N 1/00588; H04N 1/00591; H04N 1/00641; H04N 1/00652; H04N 1/0066; H04N 1/00705; H04N 1/00782

(57) ABSTRACT

An image reading apparatus, comprising a conveyance mechanism for conveying a document, an image sensor for reading an image of the conveyed document at a reading position, a first conveyance path on an upstream side of the reading position, a second conveyance path on a downstream side of the reading position, and a control unit for controlling to acquire first and second images by the image sensor while a leading edge of the conveyed document is located in the first and second conveyance paths, respectively, wherein the document is conveyed by accelerating the document to reach a predetermined speed after decelerating the document, and the acquisition of the first image is started during a period from when the document is decelerated until the predetermined speed is reached.

### BACKGROUND

### CROSS-REFERENCE TO PRIORITY APPLICATION

This application claims the benefit of Japanese Patent Application No. 2025-078180, filed May 8, 2025, which is hereby incorporated by reference herein in its entirety.

### FIELD OF THE TECHNOLOGY

The present disclosure relates to an image reading apparatus, a control method therefor, and a non-transitory computer-readable storage.

### DESCRIPTION OF THE RELATED ART

In an image reading apparatus that can sequentially execute image reading on a plurality of documents, if a foreign substance is located on an image sensor, noise may occur due to the foreign substance in an image obtained by image reading. Japanese Patent No. 4848742 discloses a technique of detecting a foreign substance located on an image sensor by image reading.

To implement the detection, it is necessary to secure the conveyance distance of a document in the apparatus in the conventional configuration, which may, for example, increase the size of the apparatus.

### SUMMARY

The present disclosure has been made based on recognition of the above-described problem by the present inventor and provides a technique capable of relatively easily and more appropriately implementing image reading.

One of the aspects of the present disclosure provides an image reading apparatus comprising: a conveyance mechanism configured to convey a document; an image sensor configured to read, at a reading position, an image of the document conveyed by the conveyance mechanism; a first conveyance path on an upstream side of the reading position; a second conveyance path on a downstream side of the reading position; and a control unit configured to control to acquire a first image by the image sensor while a leading edge of the document conveyed by the conveyance mechanism is located in the first conveyance path and acquire a second image by the image sensor while the leading edge of the document conveyed by the conveyance mechanism is located in the second conveyance path, wherein the control unit conveys the document by the conveyance mechanism by accelerating the document to reach a predetermined speed after decelerating the document, and starts the acquisition of the first image by the image sensor during a period from when the document is decelerated until the predetermined speed is reached.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views each showing the outer appearance of a multifunction peripheral (MFP) according to an embodiment;

FIGS. 2A and 2B are schematic partial sectional views each showing the multifunction peripheral;

FIG. 3 is a schematic enlarged sectional view of the multifunction peripheral;

FIGS. 4A and 4B are exploded perspective views of sensors;

FIGS. 5A and 5B are perspective views for explaining the configuration of the sensors in the multifunction peripheral;

FIGS. 6A, 6B, and 6C are schematic views for explaining the configuration of a scanner unit;

FIG. 7 is a schematic view for explaining the configuration of a glass frame unit;

FIG. 8 is a schematic view for explaining the configuration of a reading unit;

FIG. 9 is a system block diagram of the multifunction peripheral;

FIGS. 10A1, 10A2, 10A3, 10B1, 10B2, and 10B3 are schematic views showing the position of an image sensor in the case of an automatic document feeder scanning method;

FIGS. 11A and 11B are schematic views each showing a state near a reading position;

FIG. 12 is a flowchart for implementing abnormal pixel detection;

FIG. 13 is a block diagram for explaining processing contents by an abnormal pixel detection unit;

FIGS. 14A, 14B, 14C, and 14D are views for explaining the conveyance mode of a document when performing abnormal pixel detection;

FIGS. 15A and 15B are views for explaining exchange of signals among elements;

FIGS. 16A1, 16A2, and 16B are views for explaining abnormal pixel detection in a case where the conveyance speed of the document is different;

FIGS. 17A and 17B are views for explaining abnormal pixel detection in a case where the conveyance speed of the document is different;

FIG. 18 is a block diagram for explaining processing contents by the abnormal pixel detection unit;

FIGS. 19A, 19B, and 19C are views for explaining another mode of abnormal pixel detection; and

FIGS. 20A, 20B, and 20C are views for explaining still another mode of abnormal pixel detection.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Overall Configuration

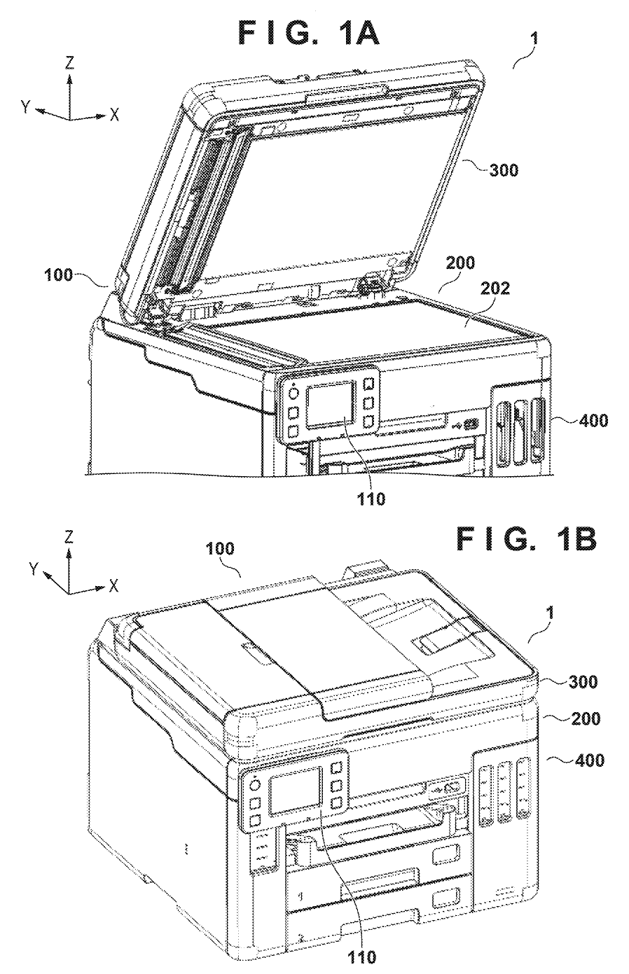

FIGS. 1A and 1B are perspective views each showing the outer appearance of a multifunction peripheral (MFP) 1 according to the first embodiment. The multifunction peripheral 1 includes an image reading apparatus 100 having a scanner function and a printing apparatus 400 having a print function. The multifunction peripheral 1 may further have additional functions such as a facsimile function in addition to the scanner function and the print function. Note that in the drawings, X, Y, and Z indicate directions crossing each other (directions substantially orthogonal to each other). The X direction corresponds to the left/right direction or the widthwise direction, the Y direction corresponds to the front/rear direction or the depth direction, and the Z direction corresponds to the up/down direction or the height direction.

Assume that the printing apparatus 400 is an inkjet printer that implements printing (recording) by discharging ink. Printing indicates forming an image on a sheet (a print medium such as a paper material), and the concept of an image includes a character, a number, a symbol, a graphic, and a photograph regardless of whether the image is visible. Ink is typically a solution containing dye or pigment, but is a liquid in a broad sense, including a reaction liquid for fixing the solution onto the sheet.

The image reading apparatus 100 includes a scanner unit (reading unit) 200 and an Auto Document Feeder (ADF) unit 300. The ADF unit 300 can be opened/closed with respect to the scanner unit 200.

FIG. 1A shows a state in which the ADF unit 300 is opened (to be sometimes simply referred to as an open state hereinafter). FIG. 1B shows a state in which the ADF unit 300 is closed (to be sometimes simply referred to as a closed state hereinafter). The user can set the ADF unit 300 in the open state, and place, on the scanner unit 200, a document as a sheet on which an image is formed.

As examples of a method of reading the image of the document, there are provided two methods of a fixed document scanning method (flatbed reading, so-called fixed reading) and an automatic document feeder scanning method (ADF reading, so-called feeder reading). In the fixed document scanning method, image reading is performed while fixing a document placed (or set) on a predetermined placement surface in this state. In this embodiment, image reading is performed by relatively moving a reading unit with respect to a document on a document placement table 202 with a translucent plate material such as a glass plate as a placement surface. In the automatic document feeder scanning method, image reading is performed while taking documents stacked on a predetermined table in the apparatus one by one and conveying them (note that the number of documents may be one). In this embodiment, image reading is performed by relatively moving a document by the ADF unit 300 with respect to the reading unit fixed in the apparatus.

In addition, an operation unit 110 is arranged on the front side of the printing apparatus 400, and the user can perform, using the operation unit 110, an operation input to use each function of the image reading apparatus 100.

### ADF Unit

The automatic document feeder scanning method can be implemented as follows.

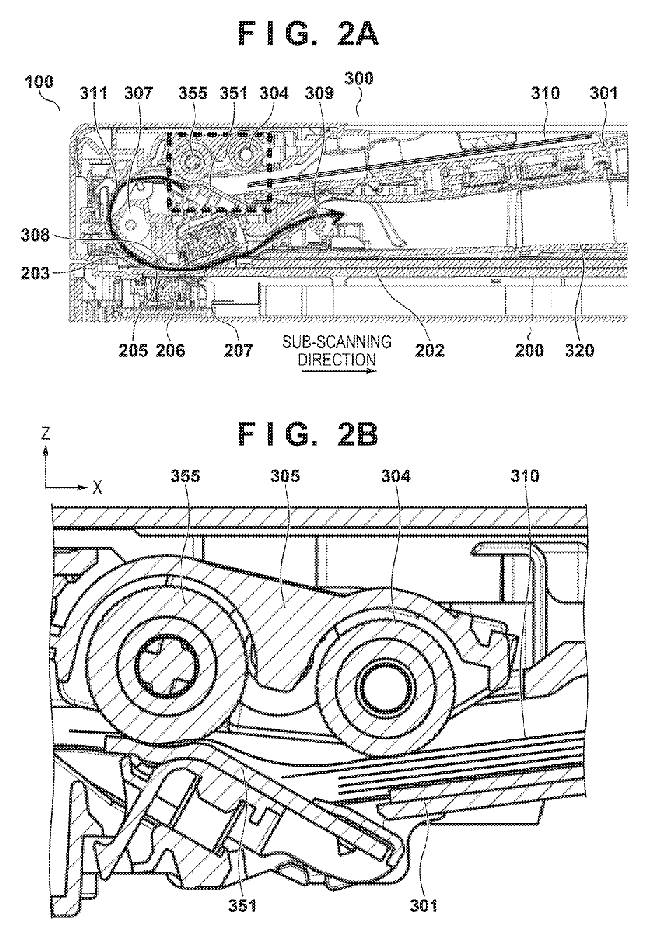

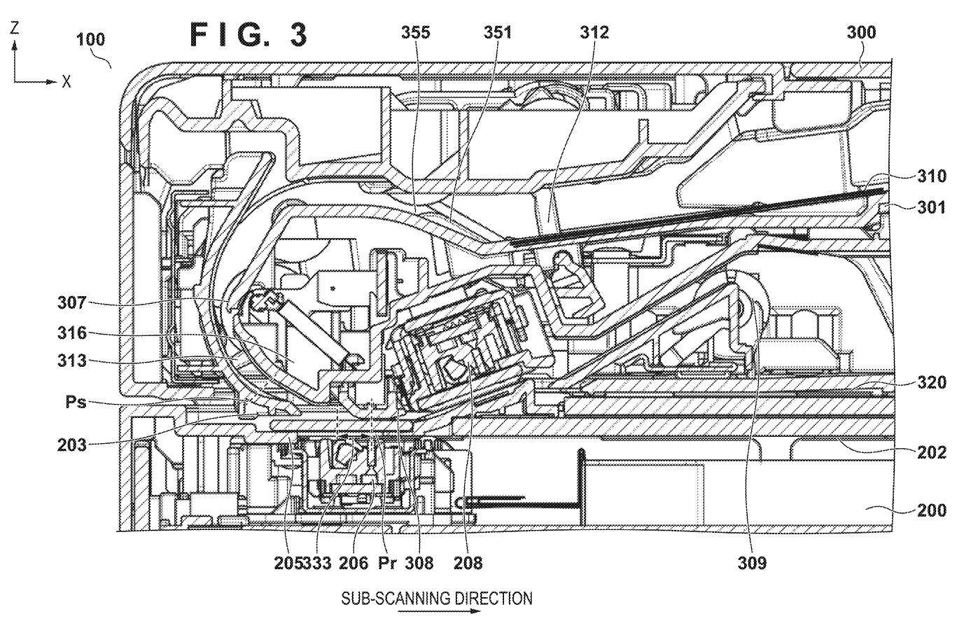

FIG. 2A is a schematic sectional view of the X-Z plane of the scanner unit 200 and the ADF unit 300 in a case where the ADF unit 300 is in the closed state, and a thick solid arrow indicates a path (document conveyance path) 311 through which a document 310 passes by conveyance. A portion of the document conveyance path 311 is formed by a portion of the scanner unit 200. FIG. 2B is an enlarged view for explaining another state in a region indicated by broken lines in FIG. 2A.

The scanner unit 200 includes the document placement table 202, a conveyance guide 203, a translucent plate material 205, and a reading unit 207. The ADF unit 300 includes a document take-in placement table 301, a pickup roller 304, a pickup arm 305, a conveyance roller 307, a white press plate 308, a discharge roller 309, a discharged document stacking portion 320, a document separation unit 351, and a separation roller 355. The ADF unit 300 further includes a conveyance mechanism for conveying a document (a part/whole of the above-described roller may form a part of the conveyance mechanism), thereby making it possible to drive the conveyance roller 307 by, for example, a motor (not shown) to convey a document. As shown in FIG. 2B, the pickup roller 304 can press the document 310 when the pickup arm 305 lowers. Note that the document conveyance mechanism portion is formed by a plurality of elements discretely arranged around the document conveyance path 311, and mainly indicates all the elements associated with a path from the pickup roller 304 to the discharge roller 309.

In a case where an operation input for instructing to start reading is input via the operation unit 110, a driving motor (not shown) rotates. In synchronism with this, the separation roller 355 and the pickup roller 304 rotate, and the pickup arm 305 accordingly lowers to cause the pickup roller 304 to press the document 310. The document 310 on the document take-in placement table 301 is taken in the apparatus by the rotation of the pickup roller 304, and conveyed to the conveyance roller 307 while being nipped between the separation roller 355 and the document separation unit 351. While the document 310 is nipped between the separation roller 355 and the document separation unit 351, other documents 310 abut against the document separation unit 351, thereby suppressing other documents from being taken in the apparatus. With this configuration, the documents 310 are separated one by one, taken in the apparatus, and conveyed.

Note that the separation roller 355 can rotate to obtain a conveyance speed lower than those of the conveyance roller 307 and the discharge roller 309, thereby forming a predetermined interval between a given document 310 and a next document 310.

The document 310 conveyed to the conveyance guide 203 by the conveyance roller 307 is conveyed while being pressed by the white press plate 308 in tight contact with the translucent plate material 205. During this operation, image reading is performed on the document 310 by an image sensor 206 of the reading unit 207.

Note that the white press plate 308 need not be a plate shape (for example, a roller is possible), and may be referred to as the white press member 308. The white press plate 308 is white, which is the base color of a typical document, but need only be the same color as the base color of a document, and may be referred to as the single-color press plate 308 or single-color press member 308 or may simply be referred to as the press plate 308 or the press member 308.

As shown FIG. 3, a plurality of document detection sensors are arranged in the document conveyance mechanism portion. In this embodiment, as the document detection sensors, a document presence/absence sensor 312 and a document edge sensor 313 are arranged. The document presence/absence sensor 312 can detect the presence/absence of the document 310 on the document take-in placement table 301. When the document 310 is placed on the document take-in placement table 301, the document presence/absence sensor 312 detects it. The document edge sensor 313 can detect passage of the leading edge (the edge on the downstream side in a conveyance direction) and the trailing edge (the edge on the upstream side in the conveyance direction) of the document 310, and a detection result is used to control the timing of image reading by the image sensor 206.

In a case where the document edge sensor 313 detects the leading edge of the document 310 on the downstream side of the conveyance roller 307, when the document 310 is further conveyed by a predetermined amount, image reading on the obverse surface of the document 310 is started while maintaining the conveyance of the document 310. Image reading on the obverse surface of the document 310 is performed by the image sensor 206. After that, in a case where the document edge sensor 313 detects the trailing edge of the document 310, when the document 310 is further conveyed by a predetermined amount, the image reading ends. In a case where there is the subsequent document 310 as an image reading target, the rotation of the driving motor is continued, and image reading of the subsequent document 310 is performed in the same procedure until the document presence/absence sensor 312 detects that there is no remaining document 310.

On the downstream side of the image sensor 206, an image sensor 208 for performing image reading on the reverse surface of the document 310 is further arranged between the translucent plate material 205 and the discharge roller 309. When performing image reading on both surfaces of the document 310, the image sensor 208 is driven or controlled almost simultaneously with the image sensor 206. In this way, with correction according to the distances of the image sensors 206 and 208 in the conveyance direction, images can be acquired as an obverse surface image and a reverse surface image. The document 310 having undergone image reading is discharged to the discharged document stacking portion 320 by the discharge roller 309. Note that for the image sensors 206 and 208, for example, a known image capturing apparatus such as a Contact Image Sensor (CIS) is used, and sensors having the same configuration are used.

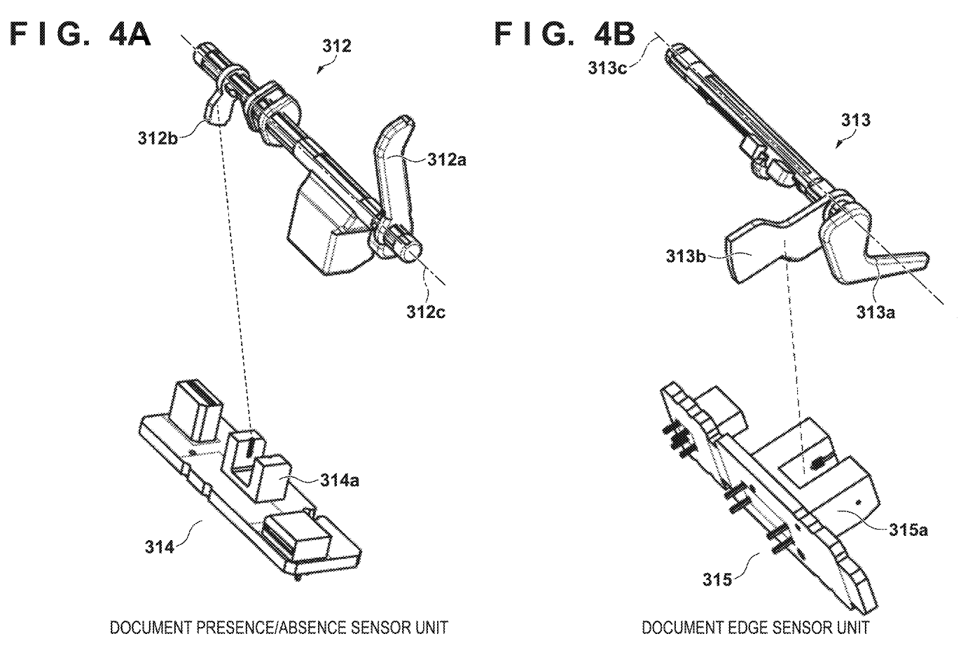

FIGS. 4A and 4B are exploded perspective views showing an example of a structure for detecting the state of the document 310. As shown in FIG. 4A, an optical sensor 314 is further arranged with respect to the document presence/absence sensor 312 (these may collectively be referred to as a document presence/absence sensor unit). As shown in FIG. 4B, an optical sensor 315 is further arranged with respect to the document edge sensor 313 (these may collectively be referred to as a document edge sensor unit).

The document presence/absence sensor 312 includes a flag portion 312a, a light shielding portion 312b, and a rotation shaft 312c, and the optical sensor 314 includes a photo interrupter 314a. The document edge sensor 313 includes a flag portion 313a, a light shielding portion 313b, and a rotation shaft 313c, and the optical sensor 315 includes a photo interrupter 315a.

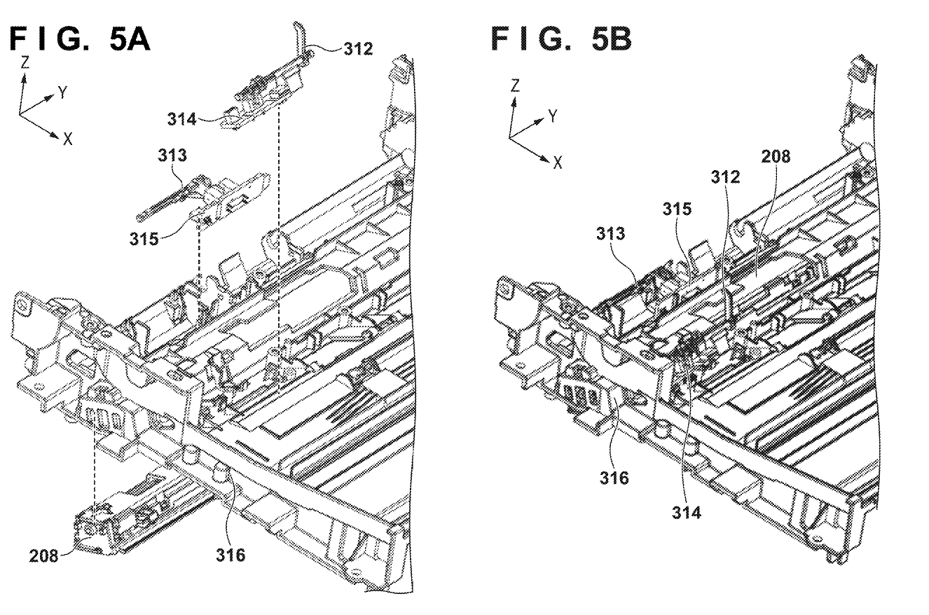

FIG. 5A shows a state in which the document presence/absence sensor unit and the document edge sensor unit are detached from a main frame 316 that forms the skeleton of the ADF unit 300. FIG. 5B shows a state in which the document presence/absence sensor unit and the document edge sensor unit are attached to the main frame 316.

The document presence/absence sensor unit can detect the document 310 based on whether the light shielding portion 312b of the document presence/absence sensor 312 shields the photo interrupter 314a in the optical sensor 314 from light. The document take-in placement table 301 is attached to the main frame 316. When the document 310 is placed on the document take-in placement table 301, the document 310 abuts against the flag portion 312a, and the document presence/absence sensor 312 pivots about the shaft 312c. Along with this, the light shielding portion 312b also pivots about the shaft 312c, and the photo interrupter 314a is not shielded from light, thereby making it possible to detect the presence/absence of the document 310.

The same applies to the document edge sensor unit, and when the document 310 is conveyed by the conveyance roller 307, the leading edge of the document 310 abuts against the flag portion 313a, and the document edge sensor 313 pivots about the shaft 313c. Along with this, the light shielding portion 313b also pivots about the shaft 313c, and the photo interrupter 315a is not shielded from light, thereby making it possible to detect the leading edge of the document 310. After the trailing edge of the document 310 passes through the flag portion 313a, the document edge sensor 313 returns to the original position to return to the state in which the photo interrupter 315a is shielded from light by the light shielding portion 313b, thereby making it possible to detect the trailing edge of the document 310. With this configuration, it is possible to determine continuous feeding of the documents 310 and adjust the start and end timings of image reading for each document 310.

### Scanner Unit

The fixed document scanning method can be implemented as follows.

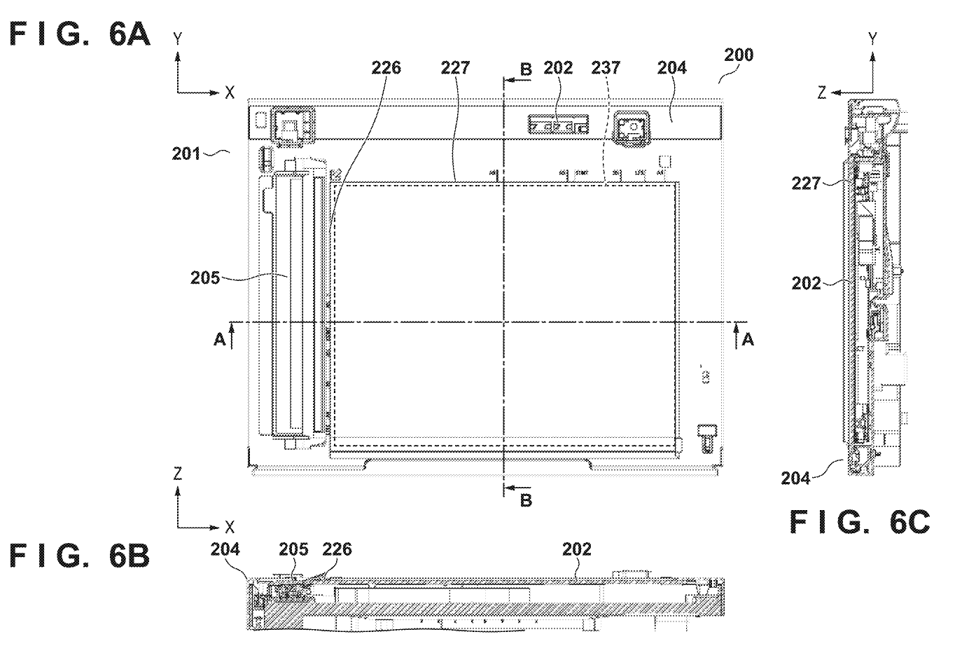

FIG. 6A is a schematic plan view showing the overall internal configuration of the scanner unit 200, and does not illustrate the ADF unit 300 for the sake of illustrative simplicity. The scanner unit 200 includes the document placement table 202 and a glass frame 204. As described above, the document placement table 202 includes a translucent plate material (in this example, a glass plate) as the placement surface of the document 310. The glass frame 204 holds a glass plate as the translucent plate material 205 for performing image reading on the document 310 taken in by the ADF unit 300. The document placement table 202 and the glass frame 204 are integrated into a glass frame unit 201.

The glass frame 204 includes a document abutment reference 226 as an abutment surface against which the document 310 abuts in the X direction, and a document abutment reference 227 as an abutment surface against which the document 310 abuts in the Y direction. The document placement table 202 includes a rectangular glass frame opening portion 237 which has two sides formed by the document abutment references 226 and 227.

FIG. 6B is a schematic sectional view of the scanner unit 200 taken along a line A - A in FIG. 6A. FIG. 6C is a schematic sectional view of the scanner unit 200 taken along a line B - B. The Y direction corresponds to the main scanning direction of the scanner unit 200, and the X direction corresponds to the sub-scanning direction of the scanner unit 200.

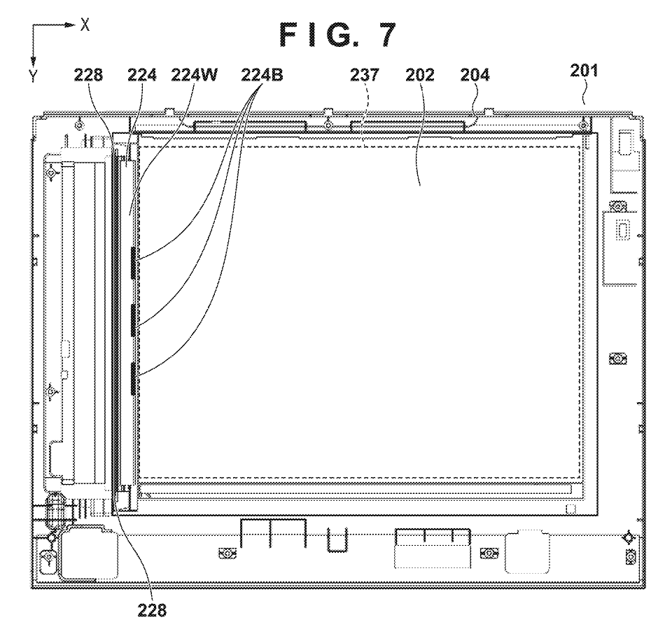

FIG. 7 is a schematic view of the glass frame unit 201 shown in FIG. 6A when viewed from the back surface side. The document placement table 202 is made to abut against two glass frame abutment portions 228 of the glass frame 204, and is positioned in the X direction.

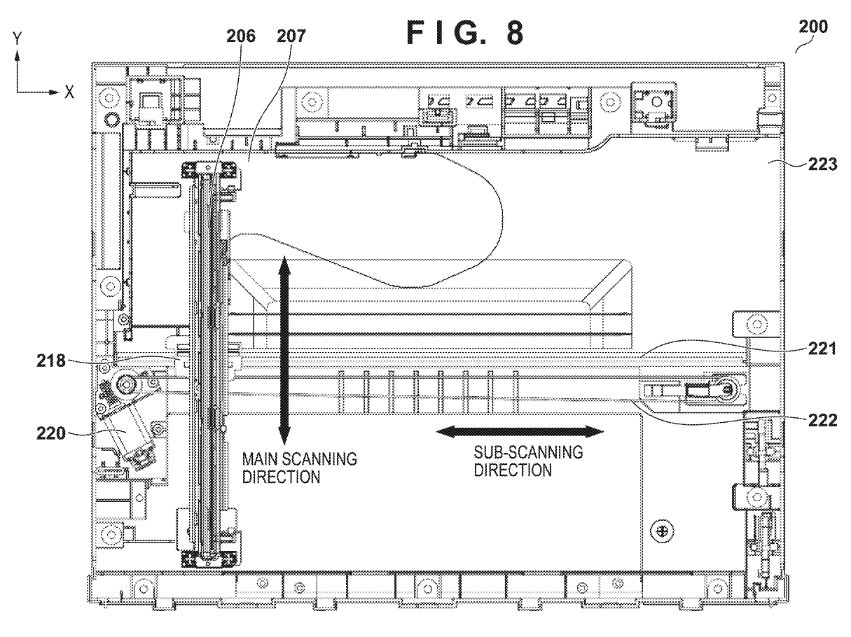

A white sheet 224 is arranged on the placement surface of the document placement table 202. In FIG. 7, the position of the white sheet 224 in the X direction is between the glass frame opening portion 237 and the glass frame abutment portions 228. In the white sheet 224, a white region 224W for shading correction of the image sensor 206 and black regions 224B serving as the reference position of the image sensor 206 in the sub-scanning direction are integrally provided (see FIG. 8). To implement shading processing, the white sheet 224 is provided with a size that can include the entire region of the image sensor 206 in the main scanning direction. The black regions 224B are provided at positions biased to the side of the glass frame opening portion 237 with respect to the white region 224W in the sub-scanning direction.

FIG. 8 is a view obtained by omitting the glass frame unit 201 and the white sheet 224 from the schematic plan view shown in FIG. 6A, and shows the arrangement relationship between a base frame 223 and the reading unit 207 including the image sensor 206. A guide rail 221 is extended along the longitudinal direction (that is, the sub-scanning direction (X direction)) of the base frame 223 almost at the central portion of the base frame 223 in the Y direction. A slider 218 of the reading unit 207 can slide in the sub-scanning direction (X direction) along the guide rail 221. When a motor 220 is driven, a belt 222 travels, and the reading unit 207 moves along the guide rail 221 via a driving transmission portion connected to the belt 222. In this way, the reading unit 207 can reciprocally move in the X direction.

Note that in this embodiment, the drive type of the reading unit 207 is a belt-driven type in which a driving unit arranged in the base frame 223 transmits a driving force by a belt. As another embodiment, a self-driving type in which a driving unit is arranged in the reading unit 207 may be used.

### System Configuration

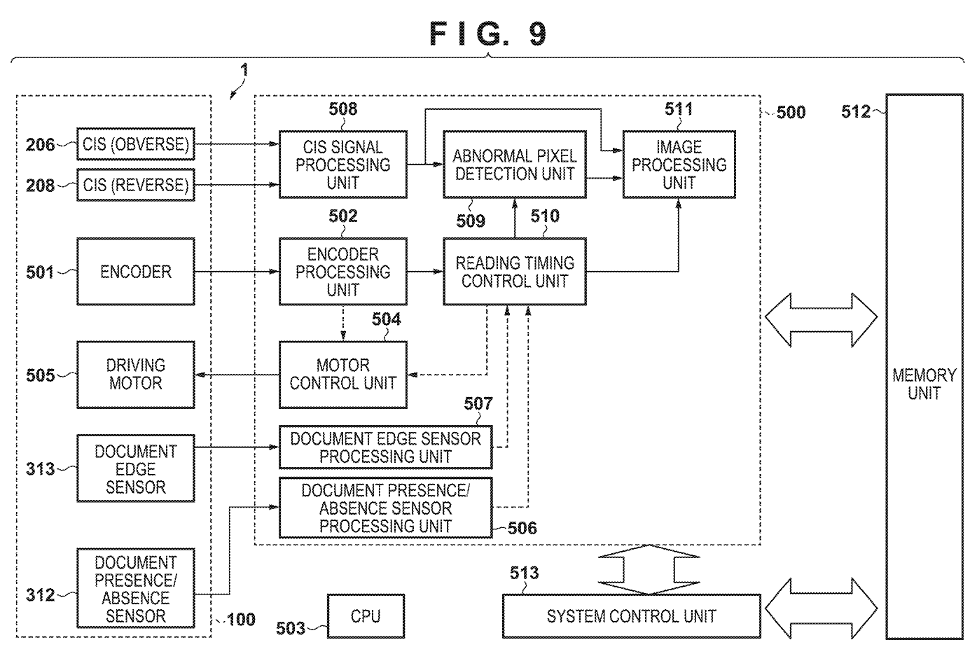

FIG. 9 is a system block diagram of the multifunction peripheral 1 for explaining image reading and abnormal pixel detection in the ADF unit 300. The multifunction peripheral 1 further includes a reading control unit 500, a CPU 503, a memory unit 512, and a system control unit 513. The reading control unit 500 can execute driving control of the image reading apparatus 100 (operation control of image reading, conveyance control of the document 310, and the like), processing of a signal (image signal or image data) of a read image thus acquired from the image reading apparatus 100, and the like. The automatic document feeder scanning method will be described below.

The image reading apparatus 100 further includes an encoder 501 and a driving motor 505. The reading control unit 500 includes an encoder processing unit 502, a motor control unit 504, a document presence/absence sensor processing unit 506, a document edge sensor processing unit 507, a CIS signal processing unit 508, an abnormal pixel detection unit 509, a reading timing control unit 510, and an image processing unit 511.

The encoder 501 operates in synchronism with the driving motor 505, and measures the driving amount of the driving motor 505, thereby making it possible to measure the conveyance amount of the document 310. For the encoder 501, a known optical rotary encoder is used. When the document 310 is scanned in the sub-scanning direction by a constant distance, an encoder pulse output from the encoder 501 is measured by the encoder processing unit 502. The CPU 503 performs feedback control of the motor control unit 504 using position information and speed information obtained by the encoder processing unit 502 so that the document 310 is conveyed at the target speed. The motor control unit 504 drives the driving motor 505 by PWM control.

The document presence/absence sensor processing unit 506 receives a signal at high level (H level) or low level (L level) from the document presence/absence sensor 312. In this example, this signal indicates that the document 310 has not reached the flag portion 312a when it is at H level, and indicates that the document 310 has reached the flag portion 312a when it is at L level. When the signal of the document presence/absence sensor 312 changes from H level to L level, the document presence/absence sensor processing unit 506 determines that the document 310 is placed on the document take-in placement table 301, and outputs, to the CPU 503, an interrupt signal corresponding to it. When the signal of the document presence/absence sensor 312 changes from L level to H level, the document presence/absence sensor processing unit 506 determines that the document 310 as an image reading target is the last page, and outputs, to the CPU 503, an interrupt signal corresponding to it.

The document edge sensor processing unit 507 receives a signal at H level or L level from the document edge sensor 313. In this example, this signal indicates that the document 310 has not reached the flag portion 313a when it is at H level, and indicates that the document 310 has reached the flag portion 313a when it is at L level. When the signal of the document edge sensor 313 changes from H level to L level, the document edge sensor processing unit 507 determines that the document 310 reaches the flag portion 313a (the leading edge of the document 310 passes), and outputs, to the CPU 503, an interrupt signal corresponding to it. When the signal of the document edge sensor 313 changes from L level to H level, the document edge sensor processing unit 507 determines that the document 310 passes through the flag portion 313a (the trailing edge of the document 310 passes), and outputs, to the CPU 503, an interrupt signal corresponding to it.

Image signals output from the image sensor 206 serving as a CIS are converted into digital signals by an analog/digital converter (not shown), sorted by the CIS signal processing unit 508, as needed, and then input to the abnormal pixel detection unit 509. After that, a first detection image and a second detection image necessary for abnormal pixel detection (to be described later) are acquired using the input image signals in accordance with a trigger output from the reading timing control unit 510, and details thereof will be described later. This processing is performed based on information indicating the presence/absence of the leading edge of the document 310 obtained from the document edge sensor processing unit 507 and information indicating the position of the document 310 obtained from the encoder processing unit 502.

The result of abnormal pixel detection is output to the image processing unit 511. Details of the timing of performing abnormal pixel detection will be described later.

The image signals from the CIS signal processing unit 508 are also input to the image processing unit 511. The image processing unit 511 performs image processing on the image signals input from the leading edge to the trailing edge of the document 310. This image processing can be performed based on information indicating the presence/absence of the leading edge and the trailing edge of the document 310 obtained from the document edge sensor processing unit 507 and information indicating the position of the document 310 obtained from the encoder processing unit 502. For example, the image processing unit 511 can perform correction processing on an abnormal pixel detected by the abnormal pixel detection unit 509. The image signals having undergone the image processing are stored in the memory unit 512. The image signals stored in the memory unit 512 can be output, by the system control unit 513, to a personal computer (PC) via an interface such as a USB cable. At the time of printing, the system control unit 513 transmits the image signals to a print unit or print processing unit (not shown).

The reading control unit 500, the CPU 503, the memory unit 512, and the system control unit 513 may collectively be referred to as a control unit, and some/all of them may be provided as part of the image reading apparatus 100.

### Abnormal Pixel Detection

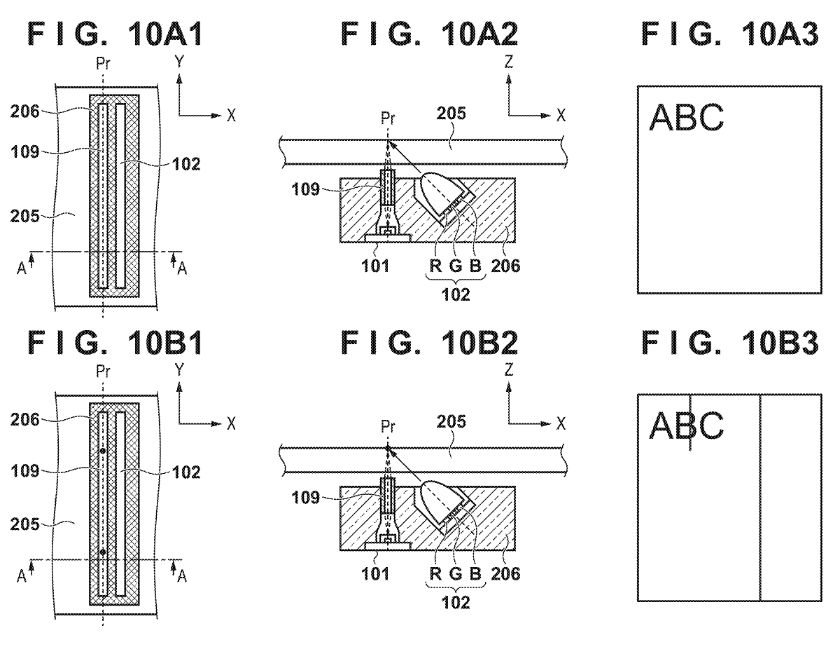

In the case of the automatic document feeder scanning method, as shown in FIGS. 10A1, 10A2, 10A3, 10B1, 10B2, and 10B3, the image sensor 206 stands by at a position immediately below the translucent plate material 205, and performs image reading on the document 310 that relatively moves by conveyance with respect to the image sensor 206. A position where image reading is performed is indicated as a reading position Pr in the drawings, and corresponds to the position of the image sensor 206 that is standing by.

FIG. 10A1 is a schematic plan view of the image sensor 206 showing a state on the upper surface side of the translucent plate material 205. FIG. 10A2 is a schematic sectional view taken along a cut line A - A. FIG. 10A3 shows an example of the image of the document 310 read by the image sensor 206.

The image sensor 206 includes three types of light emitting elements 102, a rod lens array 109, and a light receiving element 101. For the three types of light emitting elements 102, LEDs are typically used, and generate light beams of different colors (in this example, light beams of red (R), green (G), and blue (B)). For the light receiving element 101, a CCD/CMOS image sensor is typically used, and light (reflected light) emitted from the light emitting element 102 and then reflected by the surface of the document 310 is guided by the rod lens array 109 to enter the light receiving element 101, and is then detected. The three types of light emitting elements 102 are sequentially switched and driven (turned on), and the image sensor 206 detects reflected light from the document 310 for each color, thereby performing color separation reading.

If there is no foreign substance at the reading position Pr, the thus obtained image includes no noise such as streaks (see FIG. 10A3). Assume here that the foreign substance indicates dust or contamination adhered to a portion immediately above the reading position Pr, a flaw formed in a portion immediately above the reading position Pr, or the like.

On the other hand, FIGS. 10B1-10B3 show a case where there are foreign substances at the reading position Pr, like FIGS. 10A1-10A3. If a foreign substance indicated by a black circle mark () is read at the reading position Pr, as an example, streak-like noise extending in the sub-scanning direction may occur in an image due to the foreign substance (see FIG. 10B3).

Although described in detail later, a pixel where such noise occurs is set as an abnormal pixel, thereby making it possible to detect the position of the foreign substance in the main scanning direction (Y direction). Although described in detail later, this abnormal pixel detection is performed by acquiring the first detection image and the second detection image and comparing them.

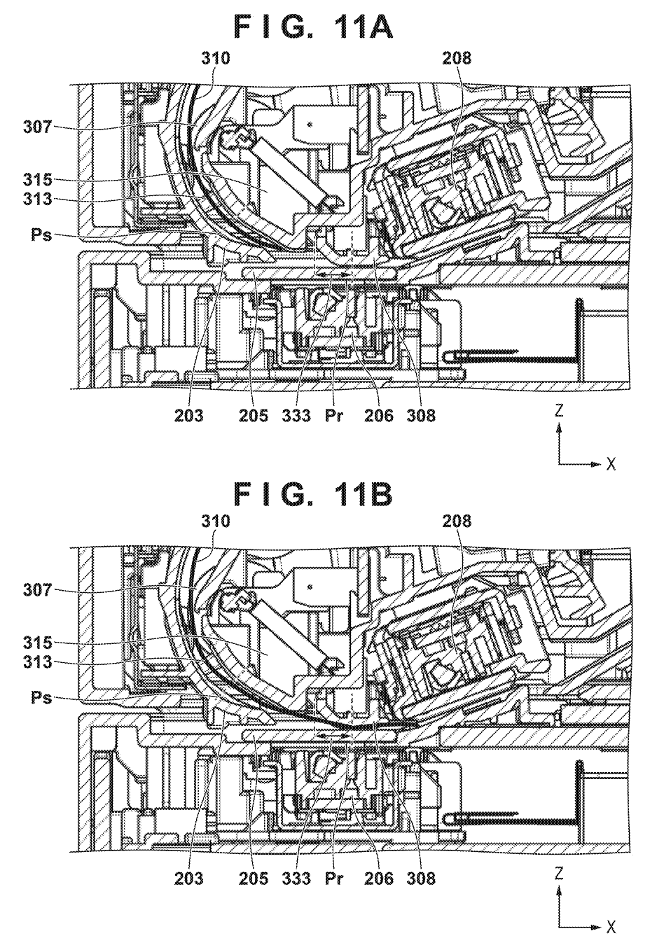

FIG. 11A shows a state near the reading position Pr when acquiring the first detection image, and FIG. 11B shows a state near the reading position Pr when acquiring the second detection image.

First, before the document 310 passes through the reading position Pr (in the state shown in FIG. 11A), the white image of the white press plate 308 is read via the translucent plate material 205, and acquired as the first detection image (the first detection image may simply be referred to as the first image). If the document 310 contacts the white press plate 308, the white press plate 308 separates from the translucent plate material 205 by the thickness of the document 310, and thus shading may occur in the first detection image, thereby making it difficult to appropriately acquire the first detection image. Therefore, in a region 333 on the upstream side of the reading position Pr where the document 310 contacts the white press plate 308, it is preferable to avoid acquisition of the first detection image (the region 333 will be referred to as the non-detection region 333 hereinafter). Note that the non-detection region 333 is set in consideration of the skew and positional deviation of the document 310 caused by tolerance in the apparatus.

Then, after the document 310 is conveyed to pass through the reading position Pr (in the state shown in FIG. 11B), an image of the leading edge portion of the document 310 is read via the translucent plate material 205, and acquired as the second detection image (the second detection image may simply be referred to as the second image). Based on line data for each color in the thus obtained first detection image and second detection image, abnormal pixels for a plurality of lines, which continuously exist at the same position in the main scanning direction (Y direction), are detected.

That is, the first detection image corresponds to the white image of the white press plate 308 read in the state in which there is no document 310, and the second detection image corresponds to an image of a margin in the leading edge portion of the document 310 as an image reading target. Therefore, by comparing the first detection image and the second detection image with each other, it is possible to detect the presence/absence of an abnormal pixel caused by a foreign substance.

Note that as described above, the white press plate 308 is preferably the same color as the base color of the document 310, but may be another color. In this case, for example, the image processing unit 511 may perform correction processing on the first detection image and/or the second detection image.

### Method of Implementing Abnormal Pixel Detection

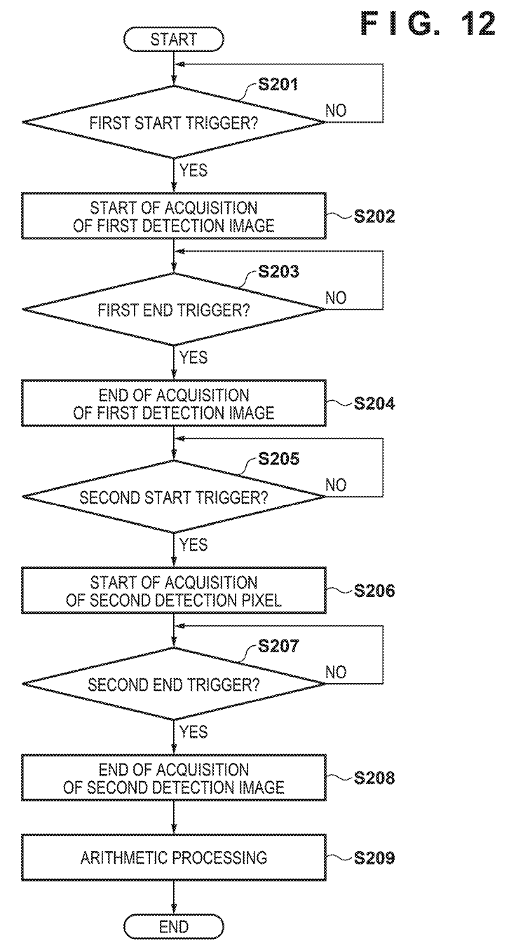

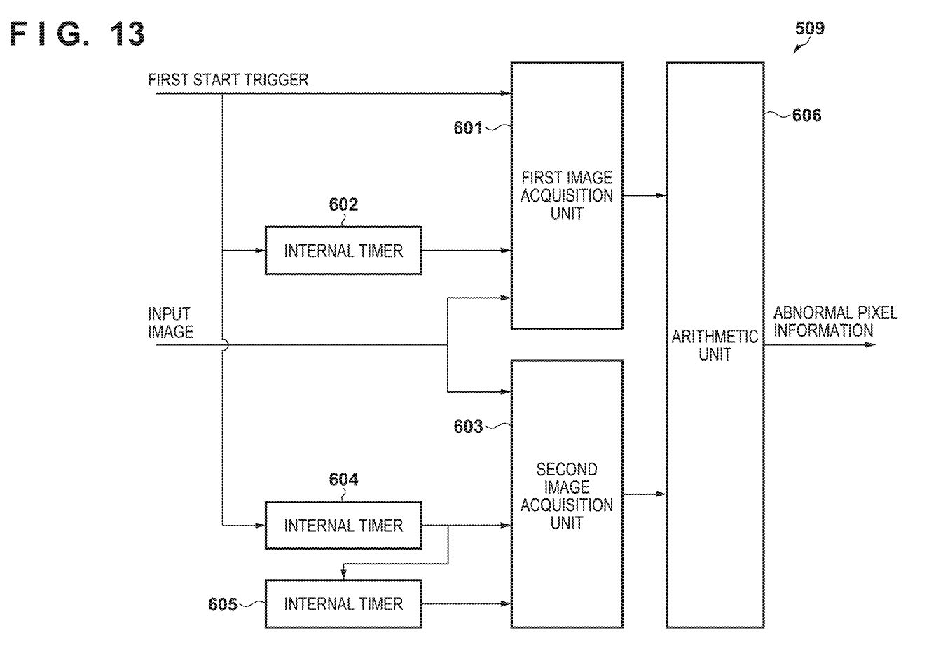

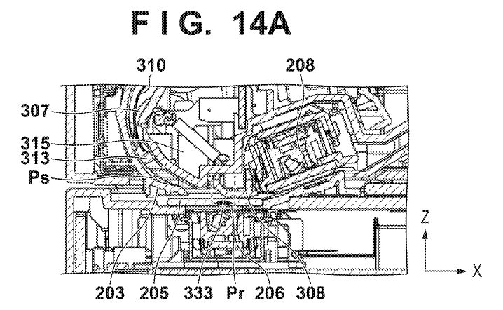

FIG. 12 is a flowchart illustrating an example of a control method of this embodiment for implementing abnormal pixel detection. FIG. 13 is a block diagram for explaining processing contents by the abnormal pixel detection unit 509. The abnormal pixel detection unit 509 includes image acquisition units 601 and 603, internal timers 602, 604, and 605, and an arithmetic unit 606.

In step S201 (to be simply referred to as S201 hereinafter) (the same applies to other steps to be described later), the presence/absence of a first start trigger is determined. If the presence of the first start trigger is determined (YES is determined), the process advances to S202; otherwise (NO is determined), the process returns to S201. Note that in this embodiment, the first start trigger is output from the reading timing control unit 510 at a timing when the leading edge of the document 310 reaches a position, at which acquisition of the first detection image is started, based on the processing result of the encoder processing unit 502.

In S202, in response to reception of the first start trigger (if YES is determined in S201), the first image acquisition unit 601 obtains an input image from the CIS signal processing unit 508, and starts acquisition of the first detection image.

The internal timer 602 is used to measure the timing of ending the acquisition of the first detection image, and the acquisition of the first detection image is performed by averaging for a plurality of lines. Therefore, a predetermined time is set in the internal timer 602, and a first end trigger is output when the predetermined time elapses.

In S203, the presence/absence of the first end trigger is determined. If the presence of the first end trigger is determined (YES is determined), the process advances to S204; otherwise (NO is determined), the process returns to S203.

In S204, in response to reception of the first end trigger (if YES is determined in S203), the first image acquisition unit 601 ends the acquisition of the first detection image.

On the other hand, the internal timer 604 is used to measure the timing of starting acquisition of the second detection image. A predetermined time is set in the internal timer 604, and the second start trigger is output when the predetermined time elapses since the first start trigger is output.

In S205, the presence/absence of the second start trigger is determined. If the presence of the second start trigger is determined (YES is determined), the process advances to S206; otherwise (NO is determined), the process returns to S205.

In S206, in response to reception of the second start trigger (if YES is determined in S205), the second image acquisition unit 603 obtains an input image from the CIS signal processing unit 508, and starts acquisition of the second detection image.

The internal timer 605 is used to measure the timing of ending the acquisition of the second detection image, and the acquisition of the second detection image is performed by averaging for a plurality of lines. Therefore, a predetermined time is set in the internal timer 605, and a second end trigger is output when the predetermined time elapses.

In S207, the presence/absence of the second end trigger is determined. If the presence of the second end trigger is determined (YES is determined), the process advances to S208; otherwise (NO is determined), the process returns to S207.

In S208, in response to reception of the second end trigger (if YES is determined in S207), the second image acquisition unit 603 ends the acquisition of the second detection image.

In S209, arithmetic processing is performed based on the first detection image obtained by the first image acquisition unit 601 in S204 and the second detection image obtained by the second image acquisition unit 603 in S208, and information indicating an abnormal pixel is output as abnormal pixel information.

### Conveyance of Document in Case Where Abnormal Pixel Detection Is Performed

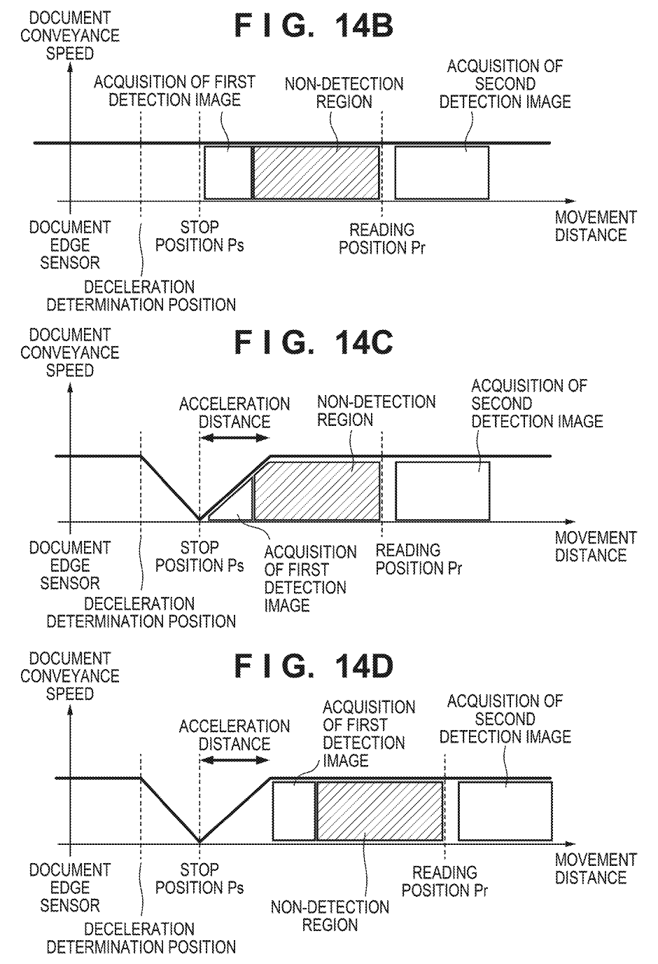

Driving control for conveying the document 310 will be described with reference to FIG. 14A. As described above, the document 310 is conveyed when the driving motor 505 driven by the motor control unit 504 rotates the pickup roller 304. After that, the position of the leading edge of the document 310 having passed through the conveyance roller 307 can be specified or calculated based on detection of the document edge sensor 313. For example, in a case where two or more documents 310 are stacked on the document take-in placement table 301, the uppermost document 310 is conveyed first. The position of the leading edge of the document 310 is specified based on the processing result of the encoder processing unit 502 after the leading edge is detected by the document edge sensor 313.

The motor control unit 504 can perform deceleration control of the driving motor 505 so that the document 310 stops at a stop position Ps when the leading edge of the document 310 reaches a predetermined position (deceleration determination position). The stop position Ps is located between the document edge sensor 313 and the reading position Pr, and the deceleration determination position is located between the document edge sensor 313 and the stop position Ps.

The reading control unit 500 controls the scanner unit 200 to start image reading.

If there is no subsequent document 310 (that is, the document edge sensor 313 detects the trailing edge of the uppermost document 310 and the document presence/absence sensor 312 detects the absence of the document 310), the reading control unit 500 ends image reading. Then, the motor control unit 504 further drives the driving motor 505 to discharge the document 310 having undergone image reading.

On the other hand, if there is the subsequent document 310, the reading control unit 500 continues image reading. More specifically, if the position of the leading edge of the subsequent document 310 reaches the deceleration determination position, the motor control unit 504 continues conveyance of the document 310 based on satisfaction of a predetermined condition.

The mode of continuously executing image reading while conveying the subsequent document 310 will sometimes be referred to as continuous feeding in this specification. In some cases, it is difficult to appropriately implement continuous feeding. For example, when performing high-resolution image reading, the required time for image reading is long and the reading speed is low, and thus acceleration may be performed after decelerating the subsequent document 310. When performing low-resolution image reading, the subsequent document 310 is generally not decelerated. However, exceptionally, if it is difficult to appropriately implement continuous feeding, acceleration may be performed after decelerating the subsequent document 310 (note that the previous document 310 may be conveyed at a constant speed).

As an example, there is a case where it is difficult to start signal processing for image reading of the subsequent document 310 because signal processing for image reading of the previous document 310 is incomplete. This is caused by, for example, shortening of the interval between the documents 310 due to differences in peripheral speed that may occur among the rollers 307, 309, and 355.

As another example of a case where it is difficult to appropriately implement continuous feeding, there is a case where the conveyance speed of the document 310 becomes low due to a rise in temperature of the motor or the like.

In this case, the motor control unit 504 performs deceleration control of the driving motor 505 so that the subsequent document 310 temporarily stops at the stop position Ps. After the document 310 stops at the stop position Ps, the motor control unit 504 drives the driving motor 505 in accordance with a conveyance resumption instruction from the system control unit 513 to accelerate conveyance of the document 310 (acceleration state). The conveyance speed of the document 310 can be calculated based on the processing result of the encoder processing unit 502. When the conveyance speed of the document 310 reaches a predetermined target speed or reference speed, the motor control unit 504 controls the driving motor 505 to make the speed of the document 310 constant (constant speed state).

Although described in more detail later, with such driving control, even if two or more documents 310 are stacked on the document take-in placement table 301, it is possible to appropriately implement image reading of all the documents.

The timing of executing abnormal pixel detection will be described with reference to FIGS. 14B-14D. In the drawings, the abscissa represents the moving distance of the document 310 with respect to the detection position of the document edge sensor 313 as the origin, and the ordinate represents the conveyance speed (document conveyance speed) of the document 310.

FIG. 14B shows a case where continuous feeding is appropriately performed. In this case, as shown in FIG. 14B, the document 310 is conveyed by the conveyance roller 307 at a constant speed. During this period, when the document edge sensor 313 detects the leading edge of the document 310, the first detection image is acquired before the leading edge reaches the non-detection region 333. After that, when the leading edge passes through the reading position Pr, the second detection image is acquired.

FIGS. 14C and 14D each show a case where it is difficult to appropriately implement continuous feeding. In this case, as shown in FIGS. 14C and 14D, after the document edge sensor 313 detects the leading edge of the document 310, the document 310 is decelerated and temporarily stopped at the stop position Ps. Then, the document 310 is accelerated until the conveyance speed becomes constant, and is then conveyed at the constant speed.

FIG. 14C shows a case where the first detection image is acquired during the acceleration, as described in this embodiment. As a comparative example, FIG. 14D shows a case where the first detection image is acquired after the acceleration is complete and the conveyance speed becomes constant.

As described above, to acquire the first detection image, the white image of the white press plate 308 is read, and thus the document 310 is conveyed at an arbitrary speed. Therefore, by acquiring the first detection image during the acceleration, as shown in FIG. 14C, the conveyance distance of the document 310 from the document edge sensor 313 to the reading position Pr can be shortened, as compared to the case shown in FIG. 14D. At this time, the accuracy of abnormal pixel detection is not lowered.

Therefore, according to this embodiment, it is possible to shorten the document conveyance path 311, which is advantageous in reducing the size of the image reading apparatus 100 or the multifunction peripheral 1.

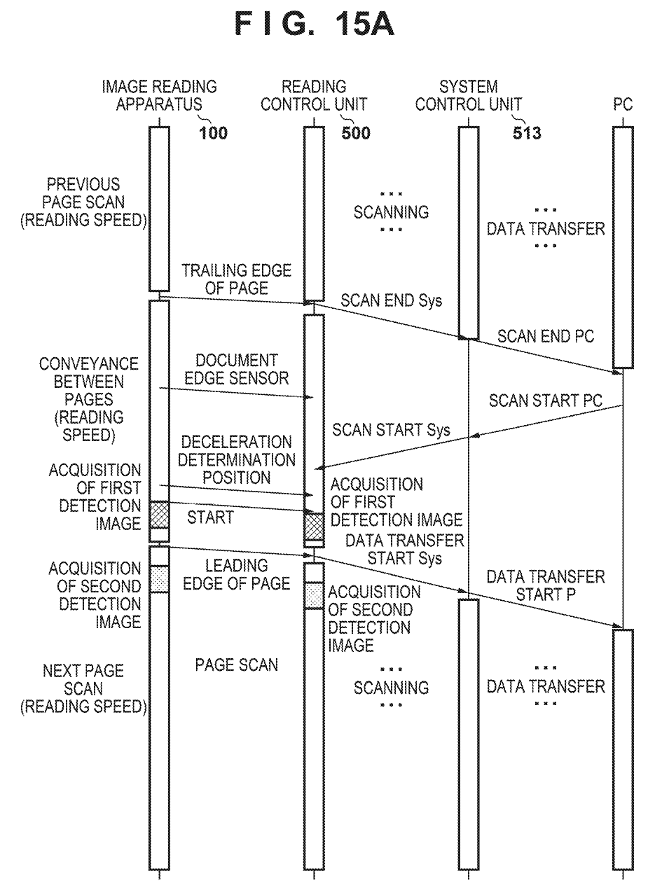

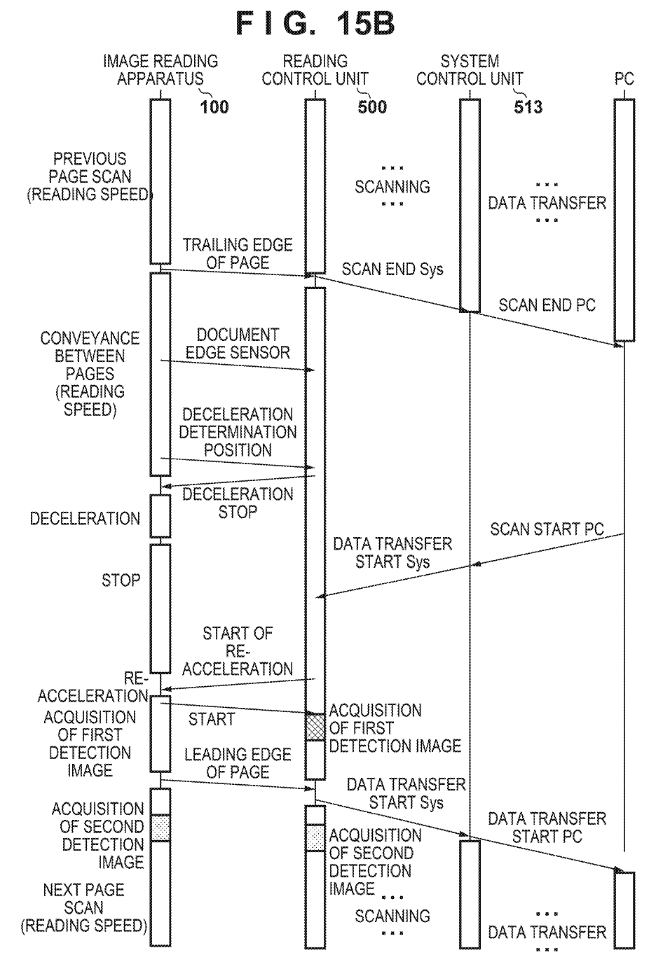

Note that in FIGS. 14B-14D, the period from the start to the end of acquisition of the first detection image corresponds to S201 to S204 in relation to FIG. 12. Similarly, the period from the start to the end of acquisition of the second detection image corresponds to S205 to S208. To implement acquisition of the first and second detection images, signals for performing driving control of the conveyance mechanism (for example, the conveyance roller 307) and the image sensor 206 are exchanged during those periods. This will be described below with reference to FIGS. 15A and 15B.

### Exchange of Signals Among Elements

FIG. 15A shows exchange of signals among the elements in a case where continuous feeding is appropriately implemented (conveyance of the document 310 is continued (see FIG. 14B)). FIG. 15B shows a case where it is difficult to appropriately implement continuous feeding (conveyance of the document 310 is stopped (see FIG. 14C)), like FIG. 15A. In the drawings, in the left/right direction, the image reading apparatus 100, the reading control unit 500, the system control unit 513, and the PC (host apparatus) are shown from the left side as elements associated with image reading, and in the up/down direction, corresponding operation contents with the lapse of time are shown.

In a case where continuous feeding is appropriately implemented (see FIG. 15A), image reading is currently executed (previous page scan) while conveying the previous document 310 at the predetermined speed (reading speed). That is, the signal processing by the reading control unit 500 for image reading of the previous document 310 is incomplete.

The system control unit 513 transfers the thus obtained image data (scan data) to the PC via an interface such as USB (data transfer). The reading control unit 500 causes the encoder processing unit 502 to measure the pulses of the encoder 501 while continuing conveyance of the document 310 at the reading speed, and ends the image reading when the trailing edge of the document 310 is conveyed (scan end). At this time, the conveyance speed of the document 310 is maintained, that is, kept at the constant speed (reading speed).

The reading control unit 500 notifies the system control unit 513 of the scan end (scan end Sys), and a response notification of the scan end for one page is sent to the PC (scan end PC) when transfer of scan data for one page ends. In response to this, the PC starts image reading of the subsequent document 310, thereby starting a scan for the next page. An instruction for this is transmitted from the PC to the system control unit 513 via the interface (scan start PC), and is also transmitted to the reading control unit 500 (scan start Sys).

When the leading edge of the subsequent document 310 (next page) reaches the document edge sensor 313, the reading control unit 500 determines the start and end positions of acquisition of the first detection image and the above-described deceleration determination position, and determines the number of pulses of the encoder 501 corresponding to them. If an image reading start instruction (scan start Sys) is input to the reading control unit 500 before the leading edge of the document 310 as the next page reaches the deceleration determination position, image reading of the next page is prepared while maintaining the conveyance. That is, the reading control unit 500 determines each of the start position of acquisition of the first detection image and the position of the leading edge of the document 310 which is the start position of image reading of the next page.

While continuing conveyance of the document 310 at the reading speed (conveyance between pages), the reading control unit 500 starts acquisition of the first detection image when the leading edge of the document 310 reaches the start position of acquisition of the first detection image. After that, when the time corresponding to a predetermined number of lines elapses, the reading control unit 500 ends the acquisition of the first detection image.

Then, when the leading edge of the document 310 reaches the start position of image reading, the reading control unit 500 starts the image reading. After that, when the time required for the leading edge of the document 310 to reach the start position of acquisition of the second detection image elapses, the reading control unit 500 starts acquisition of the second detection image. Furthermore, when the time corresponding to a predetermined number of lines elapses, the reading control unit 500 ends the acquisition of the second detection image.

Note that scan data of the next page is transferred to the PC by the system control unit 513, similar to the previous page scan.

Next, in a case where it is difficult to appropriately implement continuous feeding (see FIG. 15B), contents until the previous page scan ends are the same as in FIG. 15A. At this time, the document 310 as the next page is conveyed at the reading speed by the reading control unit 500.

However, due to reasons such as the heavy load of the PC caused by the previous page scan, a subsequent scan start instruction (scan start PC, and scan start Sys along with it) may be delayed. In this case, the document 310 as the next page undesirably reaches the deceleration determination position before the scan start instruction. Therefore, the reading control unit 500 decelerates and stops the document 310 in order to appropriately execute image reading of the next page and signal processing necessary to implement image reading (see FIG. 14C).

As described above, the reading control unit 500 stands by for reception of a scan start instruction (scan start PC, and scan start Sys along with it), and resumes conveyance of the document 310 in response to reception of the instruction.

To decelerate the document 310, the reading control unit 500 controls the conveyance motor based on a preset deceleration profile so as to implement deceleration according to the reading speed. That is, the required time for the deceleration is determined based on the deceleration profile, and the document 310 proceeds by a predetermined distance (deceleration distance) after the start of the deceleration, and then stops.

If the reading control unit 500 receives a scan start instruction during the stop of the document 310, the reading control unit 500 accelerates the document 310 to resume the conveyance, thereby starting abnormal pixel detection and image reading. At this time, a positional deviation of the document 310 may occur, and thus the start position of acquisition of the first detection image is reset. Furthermore, the time until acquisition of the second detection image starts changes from the case shown in FIG. 15A (the case where continuous feeding is appropriately implemented), and thus the time (that is, the start position of acquisition of the second detection image) is also reset. After the reset, the conveyance of the document 310 is resumed, and abnormal pixel detection and image reading are performed.

To accelerate the document 310, the reading control unit 500 controls the conveyance motor based on a preset acceleration profile so as to implement acceleration according to the reading speed. That is, the required time for the acceleration is determined based on the acceleration profile, and the document 310 proceeds by a predetermined distance (acceleration distance) after the start of the acceleration, and is then conveyed at the constant speed.

During the acceleration, when the leading edge of the document 310 reaches the start position of acquisition of the first detection image, the reading control unit 500 acquires the first detection image. After that, when the leading edge of the document 310 reaches the start position of image reading, the reading control unit 500 performs the image reading. When the leading edge of the document 310 reaches the start position of the image reading, the acceleration of the document 310 is complete and the conveyance speed is the constant speed (reading speed).

Note that scan data of the next page is transferred to the PC by the system control unit 513, similar to the previous page scan.

A case where the scan start instruction of the PC is delayed has been exemplified. However, it may be necessary to decelerate and stop the document 310 (see FIGS. 14C and 15B) in other cases. As examples, there are a case where signal processing is delayed due to shortage of memory resources and is thus interrupted, and a case where the process stands by until the heat-generating motor cools down.

### Stop Position of Document

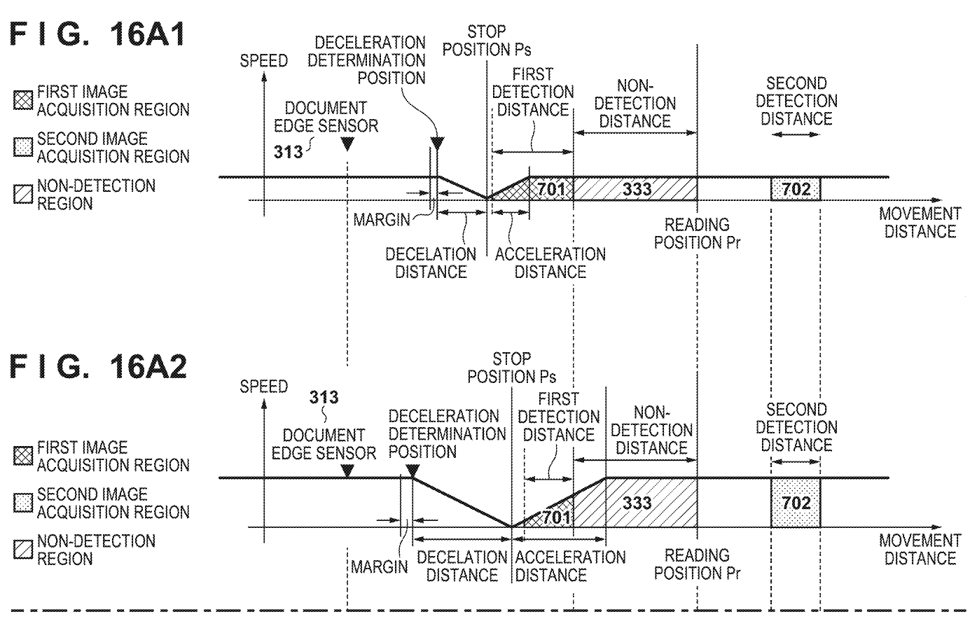

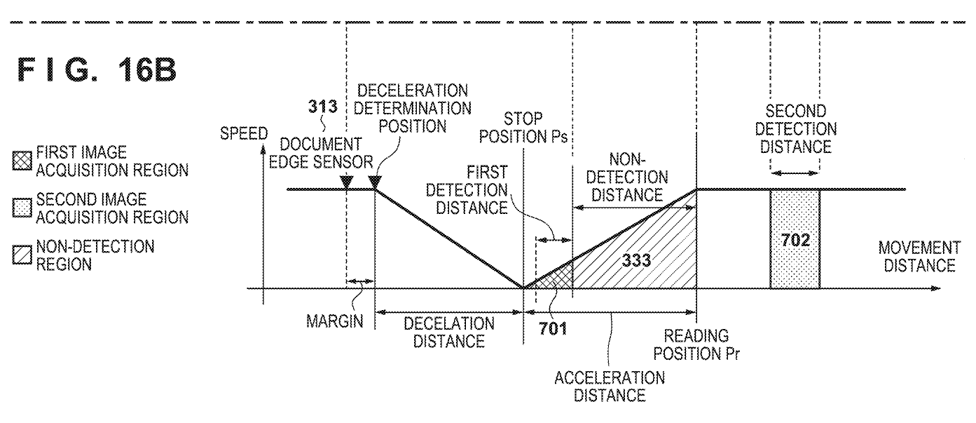

FIGS. 16A1 and 16A2 each show the timing of executing abnormal pixel detection in a case where the reading speed is relatively low, like FIGS. 14B-14D. An example shown in FIG. 16A1 indicates a case where the constant speed (reading speed) is reached during acquisition of the first detection image, and an example shown in FIG. 16A2 indicates a case where the constant speed (reading speed) is reached after acquisition of the first detection image. Similarly, FIG. 16B shows the timing of executing abnormal pixel detection in a case where the reading speed is relatively high.

A first image acquisition region 701 is indicated as a region for acquiring the first detection image, and the size (distance) in the abscissa direction is set as a first detection distance (the first detection distance may simply be referred to as a first distance). A second image acquisition region 702 is indicated as a region for acquiring the second detection image, and the size in the abscissa direction is set as a second detection distance (the second detection distance may simply be referred to as a second distance).

Note that the non-detection region 333 is a region where acquisition of the first detection image should be avoided/limited on the upstream side of the reading position Pr. The size of the region in the abscissa direction is represented as a non-detection distance.

In the drawings, the abscissa represents the moving distance of the document 310 with respect to the detection position of the document edge sensor 313 as the origin. The physical distance between the elements in the apparatus is fixed. Therefore, the position of the document edge sensor 313, the start and end positions of the non-detection distance, the reading position Pr, and the start and end positions of the second detection distance remain unchanged in the abscissa direction in all of FIGS. 16A1, 16A2, and 16B. On the other hand, the deceleration determination position and the stop position Ps are different among FIGS. 16A1, 16A2, and 16B.

That is, the acceleration distance is determined based on the acceleration profile of the conveyance motor, and is shorter as the conveyance speed is lower. On the other hand, the non-detection distance is the length of the region where acquisition of the first detection image should be avoided/limited, and is thus a fixed value. The first detection distance is determined based on the acceleration profile and the detection time, and is longer as the reading speed is lower. The deceleration distance is determined based on the deceleration profile, and is shorter as the conveyance speed is lower, similar to the acceleration distance.

For example, in the example (the example in which the reading speed is relatively low) shown in FIG. 16A2, the conveyance speed reaches the constant speed during the non-detection distance, thereby obtaining:
acceleration distance < non-detection distance + first detection distance
It is necessary to set the stop position Ps on the upstream side of the reading position Pr by non-detection distance + first detection distance. In this case, the stop position Ps does not depend on the acceleration distance.

The same applies to the example (the example in which the reading speed is lower) shown in FIG. 16A1.

On the other hand, in the example (the example in which the reading speed is relatively high) shown in FIG. 16B, the conveyance speed does not reach the constant speed during the non-detection distance, thereby obtaining:
acceleration distance ≥ non-detection distance + first detection distance
The stop position Ps is on the upstream side of the reading position Pr by the acceleration distance. In this case, the stop position Ps does not depend on the non-detection distance and the first detection distance.

Note that acquisition of the first detection image is actually started after the start of acceleration of the document 310, and thus that position (the start end of the region 701) and the stop position Ps are shifted from each other in the drawings.

The deceleration determination position is on the upstream side of the stop position Ps by the deceleration distance. Since the deceleration determination position is determined when the leading edge of the document 310 reaches the document edge sensor 313, it is necessary to arrange the document edge sensor 313 on the upstream side of the deceleration determination position.

Furthermore, the document 310 is conveyed at the reading speed from the document edge sensor 313 to the deceleration determination position. Therefore, a margin according to the required time for the signal processing of the reading control unit 500 is necessary. Since the required time for the signal processing is typically fixed, the margin is set larger as the reading speed is higher.

With respect to the deceleration determination position, it is necessary to satisfy the above condition at any reading speed. Therefore, the distance (the length of the conveyance path) from the document edge sensor 313 to the reading position Pr can be secured so as to satisfy the above condition even in a case where the reading speed is the maximum value, and the apparatus size can be determined accordingly. That is, when the total value of the non-detection distance and the first detection distance is compared with the acceleration distance, the stop position Ps need only be located on the upstream side of the reading position Pr by the longer distance of them.

Although described in more detail later, the distance from the document edge sensor 313 to the reading position Pr is preferably short to reduce the size of the apparatus. However, it is necessary to secure the acceleration distance or the total distance of the first detection distance and the non-detection distance as the distance from the stop position Ps to the reading position Pr. On the other hand, if the distance from the stop position Ps to the reading position Pr is excessively secured, it is difficult to secure the deceleration distance and the distance from the document edge sensor 313 to the deceleration determination position.

### Relationship Between Required Time and Required Distance for Abnormal Pixel Detection

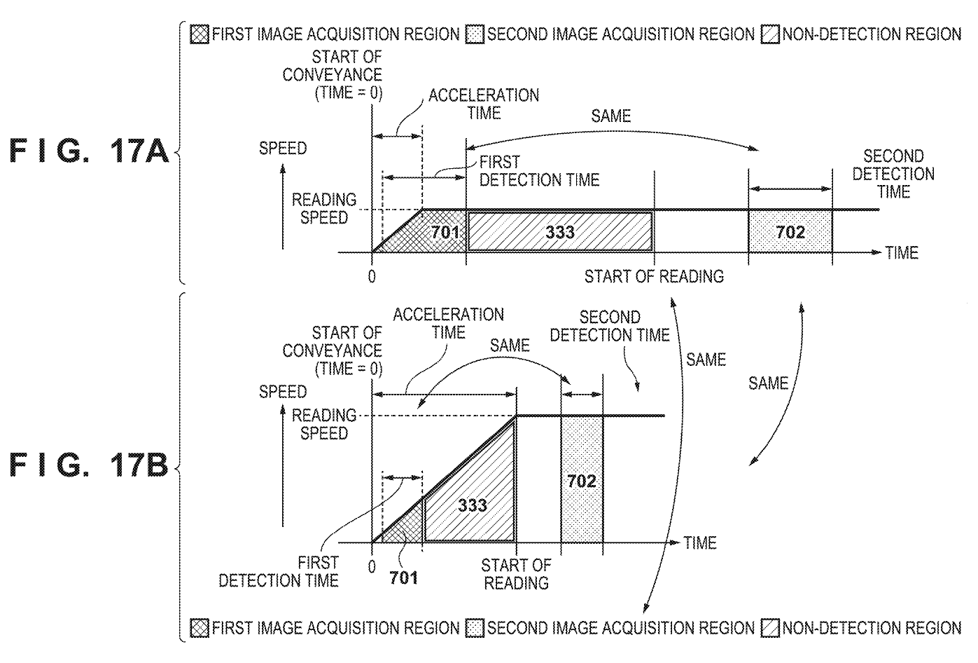

FIG. 17A shows the timing of executing abnormal pixel detection in a case where the reading speed is relatively low, which is obtained by converting the abscissa in FIG. 16A1 into the time base. FIG. 17B shows the timing of executing abnormal pixel detection in a case where the reading speed is relatively high, which is obtained by converting the abscissa in FIG. 16B into the time base.

To explain FIGS. 17A and 17B, deceleration of the document 310 need not be taken into consideration, and thus FIGS. 17A and 17B show the start timing of acceleration of the document 310 as time = 0.

The sizes (times) in the abscissa direction required for acquisition of the first detection image and the second detection image are set as a first detection time and a second detection time, respectively. Similarly, the time corresponding to the acceleration distance is shown as an acceleration time.

The distance is obtained by integrating the speed over the time. Therefore, for example, the first detection distance corresponds to an area shown as the first image acquisition region 701, and the second detection distance corresponds to an area shown as the second image acquisition region 702.

The acceleration profile of the document 310 is linear (a linear function) in this example, but may actually be an Nth-order function (N ≥ 2). In this case as well, the distance can be calculated by integrating the speed over the time.

In this example, the acceleration (the tilt of the acceleration profile) is the same between FIGS. 17A and 17B.

The first detection time and the second detection time (the sizes in the abscissa direction) are equal regardless of whether the reading speed is high or low. That is, the first detection time and the second detection time are equal in FIG. 17A, and the first detection time and the second detection time are equal in FIG. 17B.

The second detection distance (the area shown as the second image acquisition region 702) is constant regardless of whether the reading speed is high or low. That is, the second detection distance in FIG. 17A is equal to the second detection distance in FIG. 17B.

Furthermore, the non-detection distance (the area shown as the non-detection region 333) is constant regardless of whether the reading speed is high or low. That is, the non-detection distance in FIG. 17A is equal to the non-detection distance in FIG. 17B.

That is, the first detection time and the first detection distance are determined to satisfy the above conditions, thereby making it possible to appropriately acquire the first detection image. When the first detection distance is shorter, the distance from the stop position Ps to the reading position Pr can be shortened and the distance from the document edge sensor 313 to the reading position Pr can be shortened. Thus, as described above, it can be said that it is possible to reduce the apparatus size.

### Summary

The image reading apparatus 100 according to this embodiment includes at least the image sensor 206 that can read, at the reading position Pr, the image of the document 310 conveyed by the document conveyance mechanism portion, and the white press plate 308 that can press the document 310 against the image sensor 206. In the document conveyance path 311 as the conveyance path of the document 310, a portion on the upstream side of the reading position Pr and another portion on the downstream side of the reading position Pr can be distinguished as a first conveyance path and a second conveyance path, respectively. The reading control unit 500 executes control processing so as to acquire the first detection image while the leading edge of the document 310 is located in the first conveyance path and acquire the second detection image while the leading edge is located in the second conveyance path.

The first detection image corresponds to the white image of the white press plate 308 read in a state in which there is no document 310 in a portion between the image sensor 206 and the white press plate 308, and the second detection image corresponds to an image of the margin in the leading edge portion of the document 310 as an image reading target. The reading control unit 500 can detect the presence/absence of an abnormal pixel caused by a foreign substance on the image sensor 206 at the reading position Pr by performing arithmetic processing of comparing the first detection image with the second detection image.

The reading control unit 500 can perform continuous feeding by continuously executing image reading while sequentially conveying the two or more documents 310 at the constant speed, and temporarily stops (interrupts) the conveyance of the document 310 in a case where it is difficult to appropriately implement continuous feeding such as a case where an instruction from the PC (host apparatus) is delayed. In this case, after stopping the conveyance of the document 310, the reading control unit 500 resumes the conveyance by accelerating the document 310 in accordance with satisfaction of a predetermined condition, and acquires the first detection image during the acceleration of the document 310.

In this control mode, since the first detection image is acquired during the acceleration of the document 310, it is possible to shorten the conveyance path required for acquisition of the first detection image in the conventional configuration. Therefore, according to this embodiment, it is possible to appropriately detect a foreign substance on the image sensor 206 and an abnormal pixel caused by the foreign substance, and to reduce the size of the image reading apparatus 100 (and the multifunction peripheral 1).

In the control mode according to this embodiment, since the first detection image is acquired during the acceleration of the document 310, it is possible to implement abnormal pixel detection within a relatively short time. Therefore, according to this embodiment, it is possible to execute continuous image reading without delay, that is, it can be said that this embodiment is advantageous in preventing a decrease in throughput.

Furthermore, according to this embodiment, since it is possible to relatively easily implement deceleration, stop, and acceleration of the document 310 by the conveyance roller 307, and it is unnecessary to add any special element, it is possible to appropriately implement continuous image reading with a relatively simple configuration.

Between acquisition of the first detection image and acquisition of the second detection image, the leading edge of the document 310 passes through the non-detection region 333 where acquisition of the first detection image is limited. At the start of image reading of the document 310 (at the start of acquisition of at least the second detection image), the conveyance speed of the document 310 needs to have reached the constant speed. Therefore, the acceleration of the document 310 is complete before the leading edge of the document 310 completely passes through the non-detection region 333.

### Modification

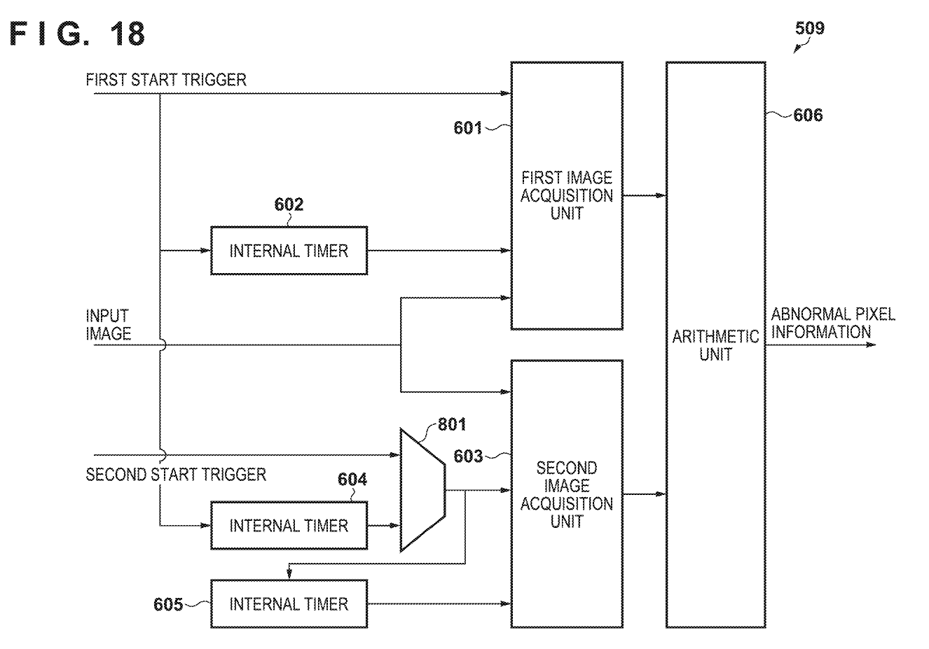

FIG. 18 is a block diagram for explaining a modification of the abnormal pixel detection unit 509. The abnormal pixel detection unit 509 further includes a start trigger selection unit 801 in addition to the configuration (see FIG. 13) of the above-described first embodiment.

In this example, it is possible to further receive a second start trigger from the reading timing control unit 510. The start trigger selection unit 801 can selectively output, to the second image acquisition unit 603, the second start trigger from the internal timer 604 and the second start trigger from the reading timing control unit 510. That is, in the above-described first embodiment, the start timing of acquisition of the second detection image is determined by measurement of the internal timer 604 (see S205 of FIG. 12). To the contrary, in this example, this timing can be determined by the reading timing control unit 510. This makes it possible to adjust the timing of acquisition of the second detection image regardless of the lapse of time.

### Second Embodiment

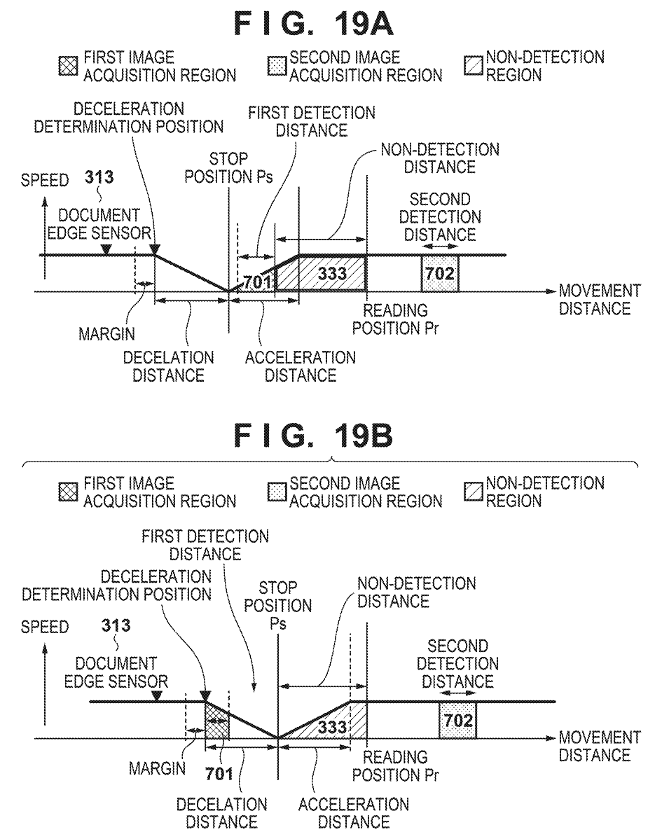

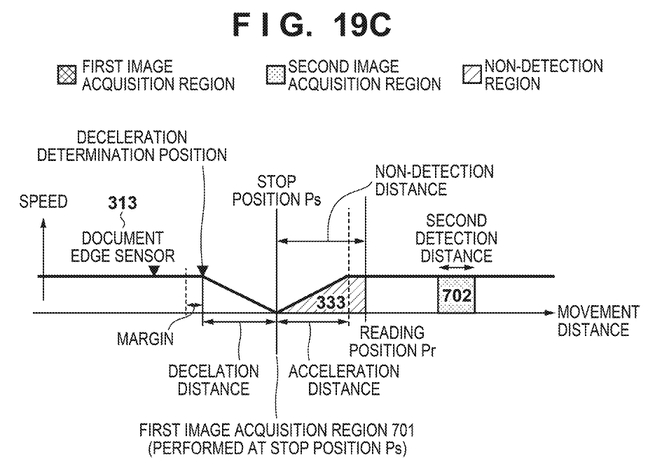

FIG. 19A is similar to FIG. 16A2 exemplified in the first embodiment. FIG. 19B shows a case where acquisition of a first detection image is executed while a document 310 is decelerated, like FIG. 19A. FIG. 19C shows a case where acquisition of the first detection image is executed while the document 310 is stopped, like FIG. 19A. Note that the speed (reading speed) when the document 310 is conveyed at the constant speed is the same among FIGS. 19A to 19C.

The example shown in FIG. 19A is the same as in the first embodiment and a description thereof will be omitted. Differences from the example shown in FIG. 19A will mainly be described below with reference to FIGS. 19B and 19C.

In a case where the leading edge of the document 310 reaches a deceleration determination position and it is determined to stop the conveyance of the document 310, a system control unit 513 causes a motor control unit 504 to control a driving motor 505 to decelerate the document 310. Accordingly, a reading timing control unit 510 outputs a first start trigger for starting acquisition of the first detection image, thereby starting acquisition of the first detection image.

In the example shown in FIG. 19B, a non-detection region 333 is located closer to a stop position Ps by a distance (first detection distance) for acquiring the first detection image than in the example shown in FIG. 19A. In other words, in this embodiment, each of the position of the document edge sensor 313, the deceleration determination position, and the stop position Ps can be made closer to a reading position Pr by the first detection distance. Therefore, in this example, it is possible to substantially shorten the distance of the conveyance path of the document 310 by the first detection distance, and to further reduce the size of an image reading apparatus 100.

Note that the first detection image corresponds to a white image of a white press plate 308, and can thus be said to be unrelated to conveyance of the document 310. Therefore, the end timing of acquisition of the first detection image is before the document 310 stops in this example, but may be after the document 310 stops.

In the example shown in FIG. 19C, after the document 310 is temporarily stopped at the stop position Ps, the reading timing control unit 510 outputs the first start trigger in accordance with the stop of the document 310 (more specifically, a measurement result by an encoder processing unit 502 becoming unchangeable). That is, acquisition of the first detection image is started while the document 310 is stopped. In this example as well, the same effect as in FIG. 19B is obtained.

As described above, the first detection image corresponds to the white image of the white press plate 308, and can thus be said to be unrelated to conveyance of the document 310. Therefore, acquisition of the first detection image may be performed while the document 310 is stopped. In this case, the first detection distance corresponds to a size (width) for one line of an image sensor 206.

Note that for acquisition of the second detection image, when it is detected, based on the processing result of the encoder processing unit 502, that the leading edge of the document 310 reaches the deceleration determination position, the output timing of a second start trigger is set. The output timing of the second start trigger can be determined based on the distance from the deceleration determination position to the start position of acquisition of the second detection image.

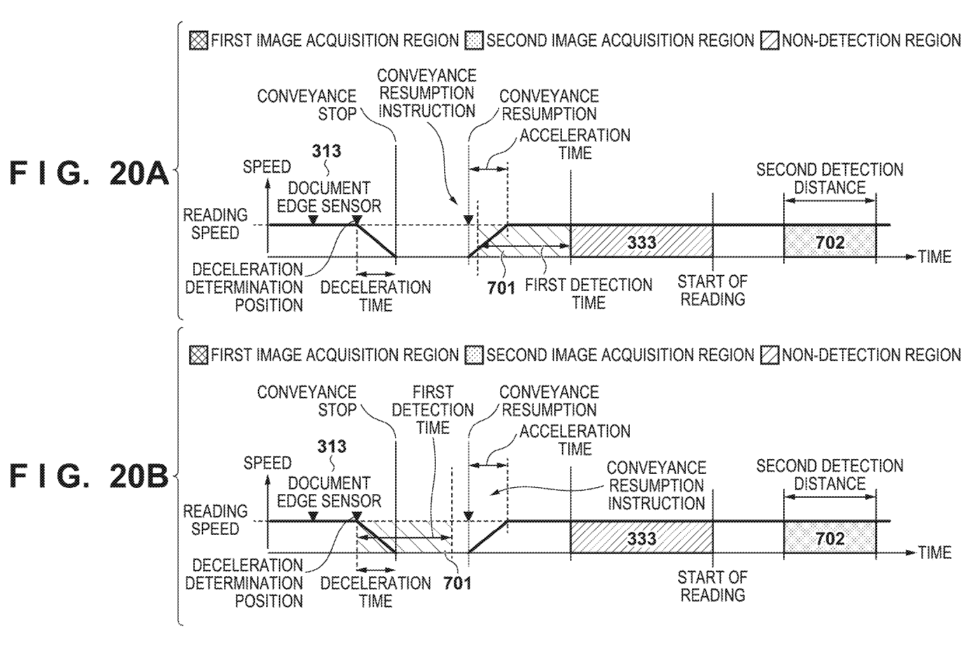

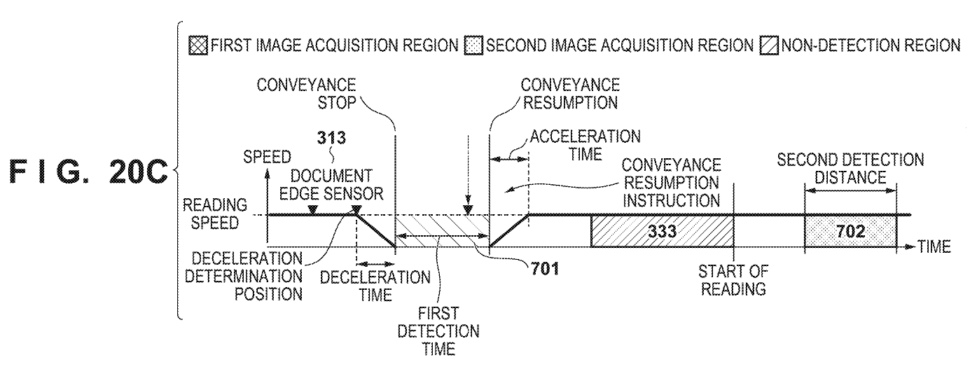

FIG. 20A is the same as FIG. 17A exemplified in the first embodiment except that the state before the stop of the document 310 is further shown. A time from the start of deceleration of the document 310 to the stop of the document 310 is shown as a deceleration time. FIG. 20B shows a case where acquisition of the first detection image is started during deceleration of the document 310 and is completed after the stop of the document 310, like FIG. 20A. FIG. 20C shows a case where acquisition of the first detection image is started almost simultaneously with the stop of the document 310 and is completed during the stop, like FIG. 20A.

The example shown in FIG. 20A is the same as in the first embodiment and a description thereof will be omitted. Differences from the example shown in FIG. 20A will mainly be described below with reference to FIGS. 20B and 20C.

In the example shown in FIG. 20B, when it is determined that the leading edge of the document 310 reaches the deceleration determination position and the conveyance of the document 310 is temporarily stopped, acquisition of the first detection image is started. Simultaneously with the acquisition of the first detection image, the document 310 is decelerated, and then stopped. In this example, since the acquisition of the first detection image ends during the stop of the document 310, the first detection time is longer than the deceleration time, as is apparent from FIG. 20B. After that, in accordance with an instruction, from the system control unit 513, to resume the conveyance of the document 310, acceleration of the document 310 is started.

In the example shown in FIG. 20C, acquisition of the first detection image is started in accordance with the stop of the document 310. In this example, the acquisition of the first detection image has not ended at the timing of receiving the instruction to resume the conveyance of the document 310. In this case, after the end of the acquisition of the first detection image, the conveyance of the document 310 is resumed. Note that this example can be adopted in a case where the trailing edge of the document 310 is detected during deceleration of the document 310.

As described above, in a case where it is difficult to appropriately implement continuous feeding, a reading control unit 500 can acquire the first detection image during deceleration and/or stop of the document 310. That is, by including the contents of the first embodiment, it can be said that acquisition of the first detection image need only be executed during a period from the start of deceleration of the document 310 along with interruption of continuous feeding to the completion of acceleration. Note that the document 310 need not be stopped for the purpose of shortening the required time to resume the conveyance of the document 310. According to this embodiment, it is possible to further shorten the distance of the conveyance path of the document 310, which is advantageous in further reducing the size of the image reading apparatus 100.

Image reading according to the above embodiment is typically, continuously performed on the plurality of documents 310. At this time, for example, in the case of high-resolution image reading, since the reading speed for each document 310 is relatively low, conveyance of any one of the second and subsequent documents 310 can temporarily be stopped. On the other hand, in the case of low-resolution image reading, since the reading speed for each document 310 is relatively high, it may be unnecessary to temporarily stop conveyance of the document 310 but the conveyance can temporarily be stopped in a case where it is difficult to appropriately implement continuous feeding.

### Program

The present disclosure may be implemented by supplying a program for implementing one or more functions of the above-described embodiments to a system or apparatus via a network or storage medium and causing one or more processors in the computer of the system or apparatus to read out and execute the program. For example, the present disclosure may be implemented by a circuit (for example, an ASIC) which implements one or more functions.

### Others

In the embodiments, each element is named by an expression based on its main function, but the function described in the embodiments may be a sub function, and the expression is not strictly limited. Furthermore, the expression can be replaced with another expression. In the same vein, an expression "apparatus" "unit", "portion", or the like can be replaced with an expression "component", "member", or the like, as needed, or may be omitted or added. The elements having the same, similar, or corresponding functions may be added with "first", "second", and the like for the sake of discrimination.

In addition, two or more elements selectably exemplified in the embodiments are not strictly limited to the exemplification and may be combined arbitrarily. For example, each of the two or more exemplified elements may be additionally selected or alternatively selected. As an example, when arbitrarily combining two elements A and B, an expression "A and/or B" or an expression "at least one of A and B" may be used to indicate only A, only B, or both A and B.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An image reading apparatus comprising:
a conveyance mechanism configured to convey a document;
an image sensor configured to read, at a reading position, an image of the document conveyed by the conveyance mechanism;
a first conveyance path on an upstream side of the reading position;
a second conveyance path on a downstream side of the reading position; and
a control unit configured to control to acquire a first image by the image sensor while a leading edge of the document conveyed by the conveyance mechanism is located in the first conveyance path and acquire a second image by the image sensor while the leading edge of the document conveyed by the conveyance mechanism is located in the second conveyance path,
wherein the control unit conveys the document by the conveyance mechanism by accelerating the document to reach a predetermined speed after decelerating the document, and starts the acquisition of the first image by the image sensor during a period from when the document is decelerated until the predetermined speed is reached.

2. The apparatus according to claim 1, further comprising a press member configured to press, against the image sensor, the document conveyed by the conveyance mechanism,
wherein the first image is a white image acquired in a state in which the document does not exist between the image sensor and the press member.

3. The apparatus according to claim 1, wherein the control unit stops the document during a period from deceleration of the document to acceleration of the document.

4. The apparatus according to claim 1, wherein the control unit completes the acquisition of the first image before the document reaches the predetermined speed.

5. The apparatus according to claim 1, wherein the control unit starts the acquisition of the second image after the document reaches the predetermined speed.

6. The apparatus according to claim 1, wherein the document is one of a plurality of documents, and the control unit accelerates the document after decelerating any one of second and subsequent documents among the plurality of documents.

7. The apparatus according to claim 1, wherein the control unit acquires the first image during acceleration of the document.

8. The apparatus according to claim 7, wherein
a non-detection region where the acquisition of the first image is limited is provided between the first conveyance path and the reading position, and
in a case where the conveyance of the document is resumed, the control unit completes the acceleration of the document while the leading edge of the conveyed document passes through the non-detection region.

9. The apparatus according to claim 8, wherein in a case where
a position at which the document stops represents a stop position,
a distance of the non-detection region in a conveyance direction of the document represents a non-detection distance,
a conveyance distance of the document necessary to acquire the first image represents a first distance, and
a conveyance distance of the document necessary to complete the acceleration of the document represents an acceleration distance,
the stop position is located on the upstream side of the reading position by a larger one of the acceleration distance and a total value of the non-detection distance and the first distance.

10. The apparatus according to claim 1, wherein the control unit acquires the first image during the deceleration of the document.

11. The apparatus according to claim 1, wherein the control unit acquires the first image while the conveyance of the document is stopped.

12. The apparatus according to claim 1, further comprising a document edge sensor configured to detect the leading edge of the conveyed document.

13. The apparatus according to claim 12, further comprising an encoder configured to measure a conveyance amount of the document and an encoder processing unit configured to measure a pulse of the encoder.

14. The apparatus according to claim 1, wherein the control unit detects a foreign substance on the image sensor at the reading position based on the first image and the second image.

15. A control method for an image reading apparatus including a conveyance mechanism configured to convey a document, an image sensor configured to read, at a reading position, an image of the document conveyed by the conveyance mechanism, a first conveyance path on an upstream side of the reading position, and a second conveyance path on a downstream side of the reading position, the method comprising:
acquiring a first image by the image sensor while a leading edge of the document conveyed by the conveyance mechanism is located in the first conveyance path; and
acquiring a second image by the image sensor while the leading edge of the document conveyed by the conveyance mechanism is located in the second conveyance path,
wherein the document is conveyed by the conveyance mechanism by accelerating the document to reach a predetermined speed after decelerating the document, and the acquiring the first image is started during a period from when the document is decelerated until the predetermined speed is reached.

16. A non-transitory computer-readable storage medium storing a program, the program configured to cause a computer to execute each step of a control method defined in claim 15.
